(19) United States
(12) Patent Application Publication
(10) Pub. No.: US 2024/0033185 A1
(43) Pub. Date: Feb. 1, 2024

(54) Burping Pad Teething Device

(71) Applicant: Jessica Roundy, Santaquin, UT (US)

(72) Inventor: Jessica Roundy, Santaquin, UT (US)

(21) Appl. No.: 18/310,751

(22) Filed: May 2, 2023

Related U.S. Application Data
(60) Provisional application No. 63/394,121, filed on Aug. 1, 2022.

(51) Int. Cl. A61J 17/00; A41B 13/00

(52) U.S. Cl. CPC A61J 17/1111; A41B 13/00

(57) ABSTRACT

The present invention relates generally to the field of accessories used in caring for infants and children. More specifically, the present invention relates to a combination burping cloth and teething device. The invention includes at least one teething member that is positioned on the top surface of the pad and is removably attached via at least one fastener. The teething member further provides an area for the infant to teeth or chew on without forcing the parent to separately hold the teething element.

### CROSS-REFERENCE TO RELATED APPLICATION

The present application claims priority to, and the benefit of, U.S. Provisional Application No. 63/394,121, which was filed on Aug. 1, 2022, and is incorporated herein by reference in its entirety.

### FIELD OF THE INVENTION

The present invention relates generally to the field of accessories used in caring for infants and children. More specifically, the present invention relates to a combination burping pad having a removable teething feature. The device is comprised of a pad with a top surface, a bottom surface, and an edge which defines a perimeter of the pad. The pad further includes a teething member that is positioned on a portion of the top surface of the pad. The teething member is removably attached by an attachment member using at least one fastener. The teething member further provides a way to mollify the infant without forcing the parent to expel effort to hold the teether separately from the pad. In the preferred embodiment, the attachment member is fixedly attached to the pad further creating additional durability. The invention includes a storage casing that provides a sanitary mode of storing or freezing the teething member. Accordingly, the present disclosure makes specific reference thereto. Nonetheless, it is to be appreciated that aspects of the present invention are also equally applicable to other like applications, devices, and methods of manufacture.

### BACKGROUND

When infants reach between four and six months in age their teeth begin to come in by breaking the gum line and the infant begins teething and needs teething devices in order to soothe the child and to aid in the process of the teeth breaking through the gum line. Teething devices are often small, and the infant may throw them or drop them. This requires the parents to constantly pick up the teething devices when the infant drops them. This can become an annoyance to parents and prevents them from getting tasks done. This requires parents to have to hold the teething device while the infant uses it, requiring two hands. When infants are burped, they can ruin the parent's or caregiver's shirt if the parent or caregiver does not have an appropriate pad, towel or other covering for their shoulder. Further, an infant may use the pad or towel for teething which can ruin the pad or towel and not effectively soothe the infant. If the infant or child chews on the pad or towel, this can contribute to choking as the towel or pad can fill the mouth of the child.

Therefore, there exists a long-felt need in the art for an improved teething device. Further, there exists a long-felt need in the art for a combination burping pad and teething device that eliminates the need for a parent to continually pick up teething devices that an infant threw on the ground. There also exists a long-felt need in the art for a combination burping pad and teething device that provides a burping pad that an infant can safely and effectively teeth on. There also exists a long-felt need in the art for a combination burping pad and teething device that provides a parent a hands-free teething device that allows them to accomplish other tasks while their child is being burped and teething.

The subject matter disclosed and claimed herein, in one embodiment thereof, comprises a combination burping pad and teething device. The device has a pad or towel with a top surface, a bottom surface, and padding contained with the towel. The device may have a pocket with an opening secured by a fastener to allow the user to insert and remove the stuffing or padding in order to wash the pad or outer towel. The device includes at least one removable teething member which is attached to the towel or pad by an attachment member using one or more fasteners. The teething member provides a way for the baby to teeth without the need for the parent to constantly hold the teething device. In addition, by providing more than one teething member on the towel or pad, the parent or caregiver can reposition the child to use the next teething member in the event that the child has regurgitated on the first teething element, thereby providing an additional clean teething element until the parent or caregiver can remove the first teething element and wash the burping towel. Further, the towel or pad has a storage casing that the one or more teething member or elements may be stored in when the element or elements is not in use, or if the parent wants to freeze the teething member. The storage casing allows a user to store the teething member in a sanitary environment without the risk of contamination.

In this manner, the combination burping pad and teething device of the present invention accomplishes all of the foregoing objectives and provides a novel childcare device that allows a parent or caregiver to have a hands-free teething device for their infant. The device further provides an all in one burping and teething device that requires minimal effort.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a burping pad or towel and one or more teething devices. The invention has a body, which may have a cushioned pad disposed in an area of the body, at least one teething member, and at least one attachment member. The pad or towel has a top surface, a bottom surface, parallel side edges, end edges forming a perimeter, and padding or stuffing provided in at least a portion of the towel or burping cloth.

The cover, pad, cloth, or towel has stuffing or padding that may be any suitable material such as foam or a sponge, to create a cushioned area in at least a portion of the towel, cloth, or pad. In one embodiment, the pad, cloth, or towel may have a pocket with an opening that is positioned on the bottom surface of the pad. The pocket provides a way for the user to remove the padding or stuffing to wash the cover or towel. In another embodiment, the cover may have a fastener that can be unfastened to remove the stuffing or padding in order to wash the cover.

The invention has a continuous edge which extends around the perimeter of the cover or pad. In the preferred embodiment, the edge is a double layered reinforced hem to attach the top surface and the bottom surface of the pad. This provides durability to the cover or pad and ensures that it will last a long time.

The invention may also have a storage cavity that allows a user to store one or more teething members or element in a sanitary environment. This sanitary storage area allows a user to be able to remove one or more of the teething members and be able to interchange them as the parent or caregiver needs them. This also allows a user to be able freeze the teething member or use other types of teething members, such as ones having different levels of softness, ones that may be coated with or containing a soothing gel or other material. If the teething member contains a soothing material, the teething member may have an internal reservoir or sponge which, when the child bites down on the teething member, some of the soothing material may be extruded through the surface of the teething member, such as through openings in the member or element to ease the pain that the child has.

The storage area or cavity has a base, a cover, and at least one fastener to secure the area. The storage case provides a sanitary way to store the teething member or elements when not in use, or if the parent or caregiver would like to freeze the teething member or replenish the supply of soothing material. The cover and the base are further attached via at least one fastener. In the preferred embodiment, the fastener is an adhesive fastener that is positioned around the outside of the cover. In another embodiment, the fastener is one of a hook and loop fastener, snap, magnet or other suitable fastener to attach the teething element to the surface of the cover or pad.

The invention further includes at least one attachment member, and at least one teething member. In the preferred embodiment, the teething member is removable and can be attached and reattached via at least one fastener. Further, in the preferred embodiment, the attachment member is fixed to the pad via the bottom surface of the attachment member. In one embodiment, the attachment member may be manufactured from any malleable plastic material known in the art. In another embodiment, the attachment member may be manufactured from any rubber material known in the art.

In the preferred embodiment, the teething member is manufactured from a non-toxic silicone material that allows an infant to safely chew or teeth on the teething member. In a different embodiment, the teething member may be manufactured from any non-toxic rubber material known in the art. Further, the teething member may have a plurality of indentations, protuberances, ridges, and other topographical features positioned on the top surface of the teething member that allows an infant to have a texture when they are using the teething member. The teething member has at least one fastener positioned on the bottom surface teething member. The fastener further attaches to the corresponding fastener located on the top surface of the attachment member.

In use, the burp cloth rests on the shoulder of the parent or caregiver and prevents an infant or child from removing the burp cloth from the individual's shoulder and throwing it on the ground. In one embodiment, the burp cloth may be weighted to ensure that the infant will not throw the device and that the burp cloth remains in position on the shoulder of the individual as the infant or child moves around. In this embodiment, there may be at least one weight located at the end of the pad. In a further embodiment, weights may be included on the side edges of the burp cloth. This would allow the ends of the pad or burp cloth to weigh the pad or towel down and prevent the infant from moving it. In another embodiment, the bottom surface may have a non-slip material, such as rubber or silicone, on a portion of the bottom surface preventing the infant from sliding the device off of the parent's shoulder. In another embodiment, the bottom surface may have at least one fastener that connects to the parent's clothes or shoulder to prevent the burp cloth from falling off the shoulder of the individual.

Accordingly, the burping cloth and teething device of the present invention is particularly advantageous as it provides a burping cloth, pad, or towel that allows the baby to teeth without the need for the parent to separately hold the teething element. In this manner, the combination burping pad and teething device overcomes the limitations of existing childcare devices known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1A illustrates a perspective view of one potential embodiment of a burping pad or cloth and teething device of the present invention in accordance with the disclosed architecture;

FIG. 1B illustrates a side elevation view of one potential embodiment of the burping pad device of the present invention and having contoured areas created by padding in predetermined areas in accordance with the disclosed architecture;

FIG. 2 illustrates a perspective view of one potential embodiment of a burping pad or cloth and teething device of the present invention with the teething member in its storage container in accordance with the disclosed architecture;

FIG. 3 illustrates a perspective view of one potential embodiment of a burping pad or cloth and teething device of the present invention with the teething member detached in accordance with the disclosed architecture; and

FIG. 4 illustrates a perspective view of one potential embodiment of a burping pad or cloth and teething device of the present invention in use in accordance with the disclosed architecture.

### DETAILED DESCRIPTION OF THE INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved teething device. Further, there exists a long-felt need in the art for a burping pad and teething device that eliminates the need for a parent or caregiver to continually pick up teething devices that an infant has dropped or thrown on the ground. There also exists a long-felt need in the art for a burping pad and teething device that provides a burping cloth or cover that an infant can safely and effectively teeth on. There also exists a long-felt need in the art for a burping pad and teething device that provides a parent with a hands-free teething device that allows the caregiver to accomplish other tasks while the child is teething.

The present invention, in one exemplary embodiment, is comprised of a burping pad and teething device. The invention includes a pad or cover with a top surface, a bottom surface, and stuffing or padding in at least a portion of the cover. The cover may include a pocket or a fastener to allow the individual to remove the stuffing or padding in order to wash the cover after use.

The invention has one or more removable teething members which is attach by an attachment member via one or more fasteners. The teething member or element provides a way for the baby to teeth or chew without the need for the parent or caregiver to constantly hold the teething device. The attachment member, in the preferred embodiment, is fixedly attached to the pad further preventing the risk of misplacing pieces of the device and preventing the child from choking on the teething member or element.

Further, the invention includes a storage case that the teething member or elements may be stored in when it is not in use, or if the parent wants to freeze, clean, refill, or replace the teething member. The storage case allows an individual to store the teething member or members in a sanitary environment without the risk of contamination.

In one embodiment the cover may be weighted to ensure that the infant will not throw or drop the device. In another embodiment, the cover may be attached to the parent or caregiver via fasteners. In another embodiment, the device may have a non-slip grip surface on the bottom surface that prevents movement of the cover while it is on the caregiver's or parent's shoulder.

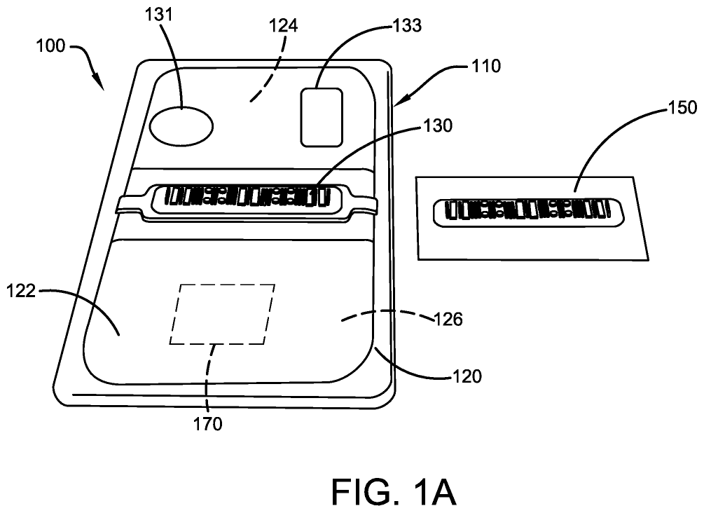

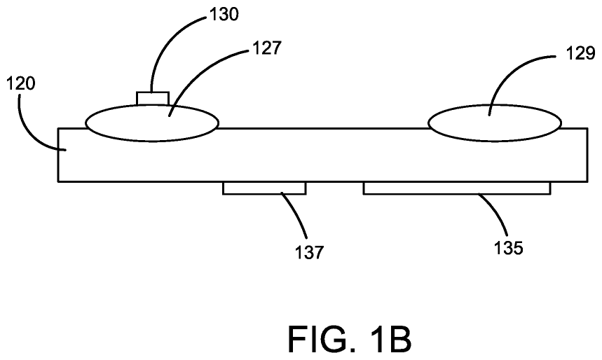

Referring initially to the drawings, FIG. 1A illustrates a perspective view of one potential embodiment of a burping pad and teething device 100 of the present invention in accordance with the disclosed specification. The invention 100 has a body or cover 110, with a pad 120, at least one teething member 130, and at least one attachment member 140. The body 110 has a pad or cover 120, a top surface 122, a bottom surface 124, and an edge 128, and stuffing or padding 126. In the preferred embodiment, the body or cover 110 of the pad 120 may be made from a soft fabric known in the art such as, but not limited to: cotton chenille, muslin cotton, velvet, cashmere, jersey knit, bamboo rayon, minky, gauze, fleece, polyester, or combinations thereof.

The pad 120 further has padding or stuffing 126 within a portion of the cover 110 to create a softer, cushioned area for greater comfort of the child. The stuffing 126 may be used so as to create contours in the pad (see FIG. 1B). The padding or stuffing may be any suitable material such as foam or a sponge. There are a plurality of non-allergenic foams or suitable material that may be used such as, but not limited to: polyurethane foam, polyester foam, ethafoam, memory foam, lux foam, rebond foam, latex foam, or combinations thereof. There also are a plurality of sponge materials that may be used such as, but not limited to: cellulose sponge, compressed cellulose sponge, natural sea sponge, woven sponge, polyethylene sponge, dental sponge, or combinations thereof. In one embodiment, the pad 120 may have a pocket that is positioned on the bottom surface 124 of the pad 120. The pocket provides a way for the user to remove the stuffing or padding 126 to wash the cover 110 or pad 120. In another embodiment, the pad 120 may have a fastener 170 that can be unfastened to remove the stuffing or padding 126 in order to wash the cover 110 or pad 120. The fastener 170 may be any fastener such as, but not limited to: magnetic, zipper, hook and loop, snap-button, adhesive, or combinations thereof.

The invention 100 has an edge 128 extending around the outside of the cover 110 to define a perimeter. In the preferred embodiment the edge is a double layered, reinforced hem to attach the top surface 122 and the bottom surface 124 of the pad 120. This provides durability to the pad 120 and ensures that it will last a long time.

The invention 100 has a storage casing 150 that allows a user to store the teething member 130 or members 131 and 133 in a sanitary environment. The teething elements 131 and 133 may be different sizes and shapes and allow for the caregiver to provide different targets on the cover for the child to seek out. Alternatively, the different teething elements 131 and 133 may allow the caregiver to attach different topographical features to the cover to allow for different stages of teething. This sanitary storage case 150 allows a user to remove the teething member 130 to interchange them as the individual needs them. This also allows a user to freeze, refill, coat, replace, or otherwise change the teething member 130.

FIG. 1B provides a side elevation of the pad 120 showing contoured areas 127 and 129 made from the padding material 126. One area 127 may be positioned for the head of the child and may include a teething element 130 and the other contoured area 129 may be positioned for the abdomen of the child. FIG. 1B also provides the position of the pocket 137 for holding the case 150 as well as the non-slip surface 135 for helping hold the cover to the shoulder of the parent or caregiver.

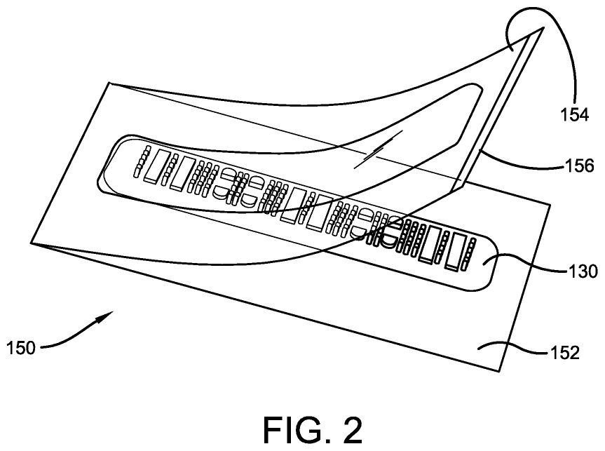

FIG. 2 illustrates a perspective view of one potential embodiment of a burping pad teething device 100 of the present invention with the teething member 130 in its storage casing 150 in accordance with the disclosed specification. The storage case 150 has a base 152, a cover 154, and at least one fastener 156 for keeping the case in a closed position. The storage casing 150 provides a sanitary way to store the teething member 130 or elements 131 and 133 when not in use. Should the parent or caregiver freeze, refill, or otherwise treat the teething member 130, the case can hold the teething member until the parent or caregiver is ready to use the teething member 130, 131 or 133. The base 152 and the cover 154 may be made from any plastic material known in the art such as, but not limited to: acrylic, polycarbonate, polyethylene, thermoplastic, acrylonitrile butadiene styrene, low-density polyethylene, medium-density polyethylene, high-density polyethylene, polyethylene terephthalate, polyvinyl chloride, polystyrene, polylactic acid, acetal, nylon, fiberglass, recycled plastic, biodegradable plastic, or combinations thereof. The cover 154 and the base 152 are further attached via at least one fastener 156. In the preferred embodiment, the fastener 156 is an adhesive fastener positioned on the outside of the cover 156. In differing embodiments, the fastener 156 may be any fastener known in the art that allows for the cover 154 and the base 152 to be securely fastened to ensure the teething member 130 is in a sanitary environment.

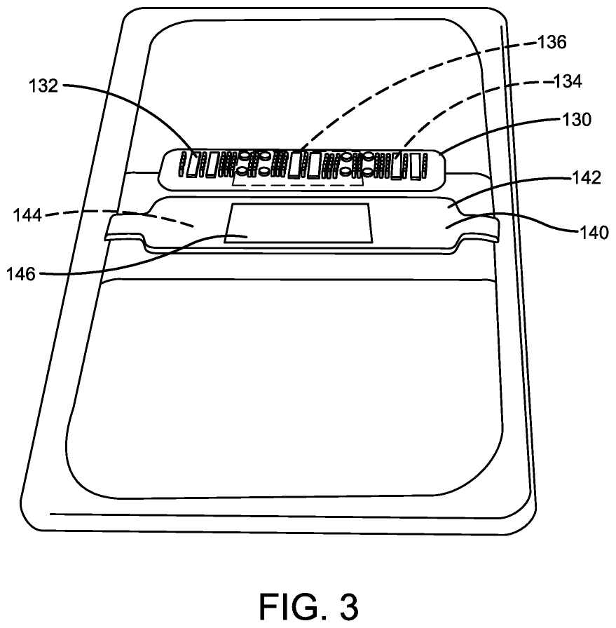

FIG. 3 illustrates a perspective view of one potential embodiment of a combination burping pad and teething device 100 of the present invention with the teething member 130 detached in accordance with the disclosed specification. The invention 100 has least one attachment member 140, and at least one teething member 130. In the preferred embodiment, the teething member 130 is removable and can be attached and reattached via at least one fastener 136, 146. Further, in the preferred embodiment, the attachment member 140 is fixed to the pad 120 via the bottom surface 144 of the attachment member 146. In one embodiment, the attachment member 140 may be manufactured from any plastic material known in the art. In another embodiment, the attachment member 140 may be manufactured from any rubber material known in the art such as, but not limited to: natural rubbers, neoprene rubber elastomer, silicone rubber elastomer, ethylene propylene diene monomer rubber, butyl rubber, nitrile rubber, buna-n rubber, styrene-butadiene rubber elastomers, viton rubber elastomer, diaphragm rubber, thermoplastic rubber, or combinations thereof.

In the preferred embodiment, the teething member 130 is manufactured from a non-toxic silicone material, such as food grade silicone that allows an infant to safely teeth on the teething member 130, 131 and 133. In a different embodiment, the teething member 130 or members 131, 133 may be manufactured from any non-toxic rubber material known in the art. Further, the teething member 130 or members 131 and 133 may have a plurality of indentations, projections, protuberances, ridges, and other topographical features positioned on the top surface 132 of the teething members 130, 131 and 133 that allow an infant to have texture when they are using the teething member 130. The caregiver may change the type of teething member 130, 131, and 133 when the child enters different stages of their teething. The teething member 130, 131, and 133 uses at least one fastener 136 positioned on the bottom surface 134 of the teething member 130 to secure the teething member to the surface of the cover 110 or pad 120. The fastener 136 further attaches to the cooperating fastener 146 located on the top surface 142 of the attachment member 140. The fasteners 136, 146 may be any fasteners such as, but not limited to: hook and loop, snap button, adhesive, magnetic, tongue and groove, and combinations thereof.

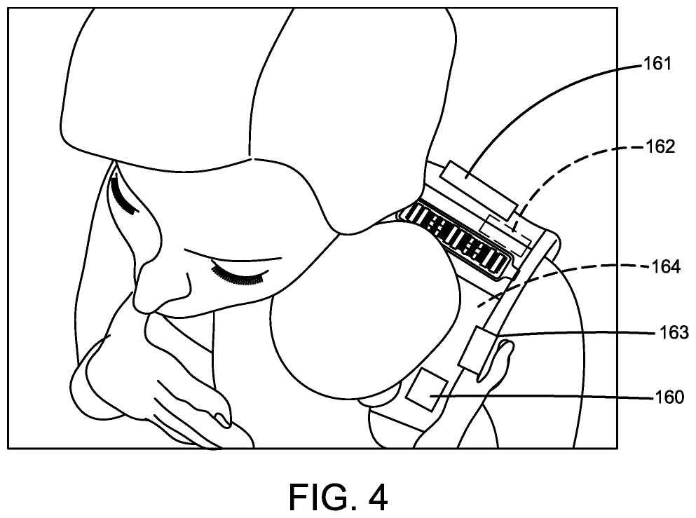

FIG. 4 illustrates a perspective view of one potential embodiment of a burping cloth and teething device 100 of the present invention in use in accordance with the disclosed specification. The invention 100 rests on the shoulder of the parent or caregiver and prevents an infant from removing the cloth 100 and dropping or throwing it on the ground. In one embodiment, the device 100 may be weighted 160 to ensure that the infant will not throw the device 100 or that the invention does not fall off the shoulder. In this embodiment, there may be at least one weight 160 located at the ends of the pad 120. This would allow the ends of the pad 120 to weigh the device 100 down and prevent the infant from moving it. More than one weight 161 and 163 may be provided and in this example, one weight is provided in the top edge and one in the side edge to help hold the cover in position on the shoulder of the individual.

In another embodiment, the bottom surface 124 may have a non-slip material 162 (or as shown in FIG. 1A) preventing the infant from sliding the device 100 off the parent's or caregiver's shoulder. There are a plurality of non-slip materials that may be used such as, but not limited to: silicone, latex, neoprene, EPDM, PVC foam, polyethylene, sponge rubber, silicone foam, urethane, cork, ridged rubber, felt, acrylic, polyester & SBR, or combinations thereof.

In another embodiment, the bottom surface 124 may have at least one fastener 164 that fastens to the parent's clothes to prevent the device 100 from falling off or from an infant pulling the device 100 off the shoulder. The fastener 164 may be any fastener known in the art such, as but not limited to: strap, snap-button, fastener, hook and loop, magnetic, or combinations thereof.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “burping pad teething device” and “device” are interchangeable and refer to the burping pad and teething device 100 of the present invention.

Notwithstanding the foregoing, the burping pad and teething device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the burping pad and teething device 100 as shown in the FIGS. are for illustrative purposes only, and that many other sizes and shapes of the combination burping pad and teething device 100 are well within the scope of the present disclosure. Although the dimensions of the combination burping pad and teething device 100 are important design parameters for user convenience, the burping pad and teething device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A burping cloth comprising:
a cover having a stuffing disposed in at least a portion of the cover to form a pad;
the cover comprised of a top surface, a bottom surface and an edge surrounding the cover and defining a perimeter of the cover; and
at least one teething member attached to the top surface of the cover.

2. The burping cloth as recited in claim 1, wherein the at least one teething member has at least one topographical feature.

3. The burping cloth as recited in claim 1, wherein the cover comprises a case for holding the at least one teething member.

4. The burping cloth as recited in claim 1, wherein the at least one teething member is attached to the cover by a fastener.

5. The burping cloth as recited in claim 1, wherein the stuffing creates contoured area on the cover.

6. The burping cloth as recited in claim 1, wherein the contoured areas are sized and configured to accommodate a head and an abdominal area of a child, respectively.

7. The burping cloth as recited in claim 1, wherein the at least one teething member is comprised of a food grade silicone.

8. The burping cloth as recited in claim 1, wherein the cover further comprises an opening.

9. The burping cloth as recited in claim 8, wherein the opening is used for removing the stuffing.

10. The burping cloth as recited in claim 4, wherein the fastener is a magnet, a zipper, a hook and loop fastener, a snap-button, an adhesive, or a combination thereof.

11. The burping cloth as recited in claim 1, wherein the edge is a double layered reinforced hem.

12. A combination burping pad and teething device comprising:
a pad having a top surface, a bottom surface and an edge defining a perimeter of the pad;
a padding provided in at least a portion of the pad;
an opening provided in the pad for removing the padding;
at least one teething element removably attached to the top surface of the pad; and
a plurality of topographical features on the teething element.

13. The combination burping pad and teething device as recited in claim 12, wherein the padding comprises contoured areas on the pad.

14. The combination burping pad and teething device as recited in claim 12 further comprising a fastener from a group consisting of a magnet, a zipper, a hook and loop fastener, a snap-button, an adhesive, or a combination thereof.

15. The combination burping pad and teething device as recited in claim 12, wherein the at least one teething element comprises different teething elements based on different teething stages of a child.

16. The combination burping pad and teething device as recited in claim 13, wherein the contoured areas include a teething element.

17. The combination burping pad and teething device as recited in claim 13, wherein at least one of the contoured areas are sized and configured to accommodate a head of a child.

18. The combination burping pad and teething device as recited in claim 12, wherein the cover comprises an additional weight.

19. The combination burping pad and teething device as recited in claim 12, wherein the bottom surface comprises a non-slip area.

20. A child accessory combination comprising:
a burping pad having a top surface, a bottom surface and an edge defining a perimeter;
at least one teething member removably attached to the top surface;
a plurality of topographical features positioned along the at least one teething member, wherein the teething member is removably attached to the top surface by a fastener;
a pocket contained in the cover;
a non-slip area provided on the bottom surface of the cover; and
a weight provided in the cover.
